(19) United States
(12) Patent Application Publication
(10) Pub. No.: US 2026/0145553 A1
(43) Pub. Date: May 28, 2026

(54) VEHICLE AND BATTERY PACK ATTACHING METHOD

(71) Applicant: TOYOTA JIDOSHA KABUSHIKI KAISHA, Toyota-shi (JP)

(72) Inventors: Tomoaki KOSHIKAWA, Mishima-shi (JP); Taro MATSUSHITA, Toyokawa-shi (JP); Yukihiko IDESHIO, Nisshin-shi (JP); Hiroaki ISHIKAWA, Toyota-shi (JP)

(73) Assignee: TOYOTA JIDOSHA KABUSHIKI KAISHA, Toyota-shi (JP)

(21) Appl. No.: 19/333,634

(22) Filed: Sep. 19, 2025

(30) Foreign Application Priority Data
Oct. 16, 2024 (JP) 2024-180799

(51) Int. Cl. B60L 50/60; B60K 1/04; H01M 50/242; H01M 50/249

(52) U.S. Cl. CPC B60L 50/66; B60K 1/04; H01M 50/242; H01M 50/249; H01M 2220/20

(57) ABSTRACT

A vehicle includes a replaceable battery pack mounted on a bottom of the vehicle. The battery pack includes a power storage device, a housing portion that houses the power storage device, a pair of connection portions disposed on both sides of the housing portion and connected to the bottom of the vehicle, and folding mechanisms for the connection portions. The folding mechanisms are configured to, when replacing the battery pack, keep the connection portions folded in a vehicle height direction until the battery pack is transported to the bottom of the vehicle, and keep the connection portions unfolded in a vehicle width direction after the battery pack is transported to the bottom of the vehicle.

### CROSS-REFERENCE TO RELATED APPLICATION

This application claims priority to Japanese Patent Application No. 2024-180799 filed on Oct. 16, 2024. The disclosure of the above-identified application, including the specification, drawings, and claims, is incorporated by reference herein in its entirety.

### BACKGROUND

### 1. Technical Field

The present disclosure relates to a vehicle and a battery pack attaching method.

### 2. Description of Related Art

Japanese Unexamined Patent Application Publication No. 2023-161332 (JP 2023-161332 A) discloses a structure of a battery pack to be mounted on a vehicle, including a housing portion that houses a power storage device (power storage module) and a connection portion that connects the battery pack to a vehicle body.

### SUMMARY

In recent years, it has been considered to transport a battery pack to the bottom of a vehicle and attach it to the vehicle with the tires in contact with the ground without lifting the vehicle. When the battery pack as disclosed in JP 2023-161332 A is transported to the bottom of the vehicle, however, the connection portion extending in the vehicle width direction may interfere with the vehicle (e.g., tires). Therefore, a more compact structure is required.

The present disclosure has been made in view of the above, and has an object to provide a vehicle including a battery pack with a compact structure that does not interfere with the vehicle, and to provide a battery pack attaching method.

The vehicle according to the present disclosure includes a replaceable battery pack mounted on a bottom of the vehicle. The battery pack includes a power storage device, a housing portion that houses the power storage device, a pair of connection portions disposed on both sides of the housing portion and connected to the bottom of the vehicle, and folding mechanisms for the connection portions. The folding mechanisms are configured to, when replacing the battery pack, keep the connection portions folded in a vehicle height direction until the battery pack is transported to the bottom of the vehicle, and keep the connection portions unfolded in a vehicle width direction after the battery pack is transported to the bottom of the vehicle.

The battery pack attaching method according to the present disclosure includes a transport step of transporting a battery pack to a bottom of a vehicle through a space between a pair of tires of the vehicle, and an attaching step of attaching the battery pack to the bottom of the vehicle by lifting the battery pack toward the bottom of the vehicle. In the transport step, the battery pack is transported to the bottom of the vehicle in a state in which connection portions configured to connect the battery pack to the bottom of the vehicle are folded in a vehicle height direction by folding mechanisms. In the attaching step, the battery pack is attached to the bottom of the vehicle in a state in which the connection portions are unfolded in a vehicle width direction by the folding mechanisms.

According to the present disclosure, interference between the battery pack and the vehicle can be suppressed when the battery pack is replaced at the bottom of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a battery pack of a vehicle and a lift according to an embodiment, and is a front view showing a state in which a connection portion of the battery pack is folded and the lift has not operated yet;

FIG. 2 is a diagram showing the configuration of the battery pack of the vehicle and the lift according to the embodiment, and is a side view showing the state in which the connection portion of the battery pack is folded and the lift has not operated yet;

FIG. 3 is a diagram showing the configuration of the battery pack of the vehicle and the lift according to the embodiment, and is a front view showing a state in which the connection portion of the battery pack is unfolded and the lift has operated;

FIG. 4 is a diagram showing the configuration of the battery pack of the vehicle and the lift according to the embodiment, and is a side view showing the state in which the connection portion of the battery pack is unfolded and the lift has operated;

FIG. 5 is a front view showing a state in which the battery pack is attached to the bottom of the vehicle according to the embodiment;

FIG. 6 is a side view showing the state in which the battery pack is attached to the bottom of the vehicle according to the embodiment;

FIG. 7 is a front view showing a configuration of a switch for operating a folding mechanism and a protrusion for pressing the switch in the vehicle according to the embodiment;

FIG. 8 is a front view showing a state in which the switch is pressed by the protrusion to attach the battery pack to the bottom of the vehicle according to the embodiment; and

FIG. 9 is a front view showing a configuration of elastic members and protrusions in the vehicle according to the embodiment.

### DETAILED DESCRIPTION OF EMBODIMENTS

A vehicle and a battery pack attaching method according to an embodiment of the present disclosure will be described with reference to the drawings. Components in the following embodiment include components that are replaceable and easy for persons skilled in the art or components that are substantially identical.

### Vehicle

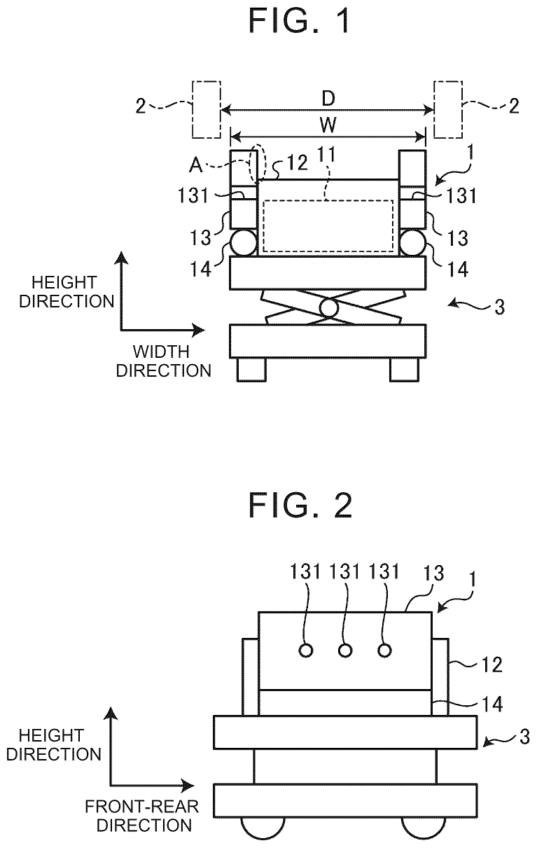

The vehicle according to the embodiment will be described with reference to FIGS. 1 to 9. The vehicle according to the embodiment is a vehicle including a replaceable battery pack (battery). Specific examples of the vehicle according to the embodiment include a hybrid electric vehicle (HEV), a plug-in hybrid electric vehicle (PHEV), and a battery electric vehicle (BEV).

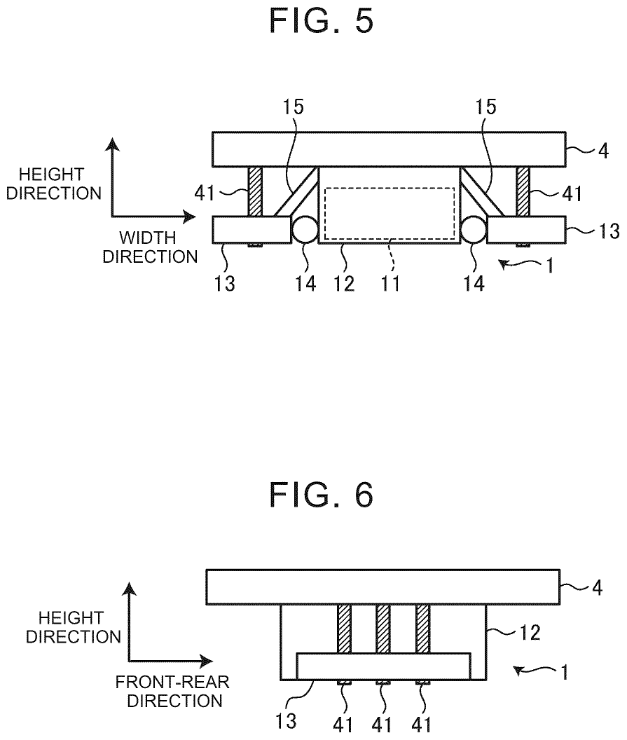

As shown in FIGS. 1 to 4, the vehicle according to the embodiment includes at least a battery pack 1 and a pair of tires 2 disposed in a vehicle width direction. As shown in FIGS. 5 and 6, the battery pack 1 is mounted on a bottom 4 of the vehicle. As described later, transportation and replacement of the battery pack 1 are performed using a lift 3 including wheels. The battery pack 1 is replaced with the tires 2 in contact with the ground without lifting the vehicle.

The battery pack 1 includes at least a power storage device 11, a housing portion 12, a pair of connection portions 13, a pair of folding mechanisms 14, and a pair of locking mechanisms 15.

The power storage device (power storage module) 11 includes a plurality of battery cells. The battery cell is a secondary battery such as a lithium ion battery. When the battery cell is the lithium ion battery, it may be either a liquid battery or an all-solid-state battery.

The housing portion 12 is a case for housing the power storage device 11. The connection portion 13 is an energy absorption (EA) member for protecting the battery pack 1 from a side impact. The connection portions 13 are disposed on both sides of the housing portion 12 via the folding mechanisms 14. As shown in FIGS. 5 and 6, the connection portion 13 is connected to the bottom 4 of the vehicle while being unfolded in the vehicle width direction by the folding mechanism 14.

The connection portion 13 has a plurality of screw holes 131 formed on the inner peripheral surface by threading. A plurality of fastening members 41 threaded on their outer peripheral surfaces is provided on the bottom 4 of the vehicle to mate with the screw holes 131. The fastening members 41 are inserted into the screw holes 131 of the connection portions 13 and fastened to them. As shown in FIGS. 5 and 6, the battery pack 1 is fixed to the bottom 4 of the vehicle via the connection portions 13. The method for fastening the fastening members 41 to the screw holes 131 is not particularly limited. For example, a mechanism for automatically rotating the fastening members 41 may be provided separately to fasten the fastening members 41 to the screw holes 131, or the fastening members 41 may manually be fastened to the screw holes 131.

The folding mechanism 14 is a hinge for folding and unfolding the connection portion 13. In the present embodiment, the folding mechanism 14 is attached to the lower side of the housing portion 12, but may be attached to a position other than the lower side of the housing portion 12 (center or upper side).

When replacing the battery pack 1, the folding mechanism 14 keeps the connection portion 13 folded in a vehicle height direction as shown in FIGS. 1 and 2 until the battery pack 1 is transported to the bottom 4 of the vehicle. The description “until the battery pack 1 is transported to the bottom 4 of the vehicle” includes, for example, the following states.
(1) State before the battery pack 1 is transported to the bottom 4 of the vehicle
(2) State after the battery pack 1 is transported to the bottom 4 of the vehicle and before the battery pack 1 is lifted by the lift 3

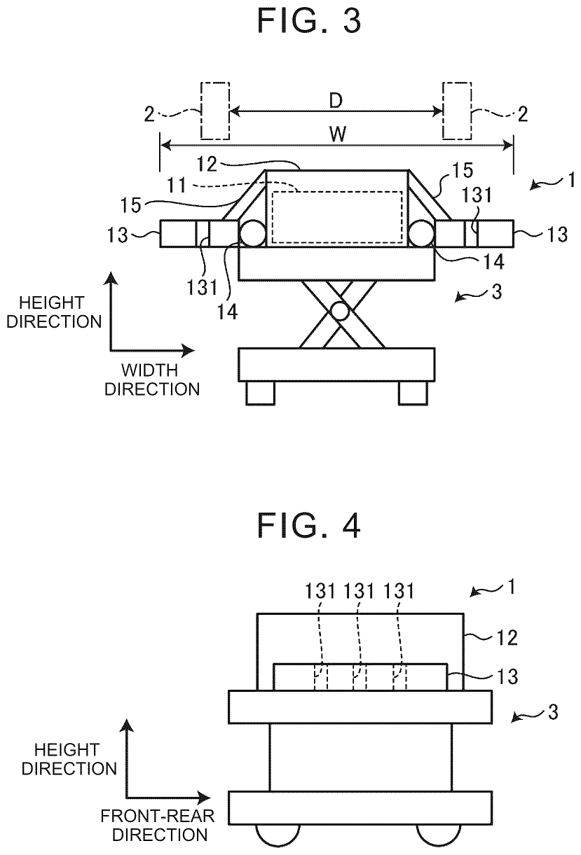

When replacing the battery pack 1, the folding mechanism 14 keeps the connection portion 13 unfolded in the vehicle width direction as shown in FIGS. 3 and 4 after the battery pack 1 is transported to the bottom 4 of the vehicle. The description “after the battery pack 1 is transported to the bottom 4 of the vehicle” includes the following states.
(1) State after the battery pack 1 is transported to the bottom 4 of the vehicle and the battery pack 1 is lifted by the lift 3
(2) State in which the battery pack 1 is attached to the bottom 4 of the vehicle

As shown in FIG. 3, when the connection portion 13 is unfolded by the folding mechanism 14, the locking mechanism 15 locks the operation of the connection portion 13 to keep the connection portion 13 unfolded. The locking mechanism 15 also functions as a reinforcing member when the connection portion 13 is unfolded, and suppresses shaking of the battery pack 1 due to vibration.

As shown in FIG. 1, when the connection portions 13 are folded by the folding mechanisms 14, a width W of the battery pack 1 is smaller than a distance D between the tires 2. As shown in FIG. 3, when the connection portions 13 are unfolded by the folding mechanisms 14, the width W of the battery pack 1 is larger than the distance D between the tires 2.

With the above relationships between the width W of the battery pack 1 and the distance D between the tires 2 before and after the connection portions 13 are folded, interference between the battery pack 1 and the tire 2 of the vehicle is suppressed when the battery pack 1 is transported to the bottom 4 of the vehicle. Further, the battery pack 1 can be replaced, for example, even when there is no sufficient space in the vehicle width direction at the bottom 4 of the vehicle. To achieve the above relationships between the width W of the battery pack 1 and the distance D between the tires 2 before and after the connection portions 13 are folded, for example, the width of the housing portion 12 and the lengths of the connection portions 13 may be adjusted relative to the distance D between the tires 2.

As shown in part A of FIG. 1, when the connection portion 13 is folded by the folding mechanism 14 in the battery pack 1, the height of the position of the tip of the connection portion 13 is larger than the height of the housing portion 12. The description “the height of the position of the tip of the connection portion 13 is larger than the height of the housing portion 12” means that the radius of rotation of the connection portion 13 when it is folded by the folding mechanism 14 is larger than the distance from the rotation axis of the folding mechanism 14 to the top of the housing portion 12. In other words, when the connection portion 13 is folded, the tip of the connection portion 13 protrudes beyond the top of the housing portion 12.

When the connection portion 13 is folded in the battery pack 1 as in FIG. 1, the height of the position of the tip of the connection portion 13 may conversely be smaller than the height of the housing portion 12. The description “the height of the position of the tip of the connection portion 13 is smaller than the height of the housing portion 12” means that the radius of rotation of the connection portion 13 when it is folded by the folding mechanism 14 is smaller than the distance from the rotation axis of the folding mechanism 14 to the top of the housing portion 12. In other words, when the connection portion 13 is folded, the tip of the connection portion 13 does not protrude beyond the top of the housing portion 12.

Since the tip of the connection portion 13 does not protrude beyond the housing portion 12 when the connection portion 13 is folded, interference between the battery pack 1 and the vehicle can be suppressed more reliably when the battery pack 1 is transported to the bottom 4 of the vehicle.

As shown in FIG. 1, the present embodiment illustrates the example in which the connection portion 13 is folded upward by the folding mechanism 14. For example, the connection portion 13 may be folded downward. Since the tip of the connection portion 13 does not protrude beyond the housing portion 12 by folding the connection portion 13 downward, interference between the battery pack 1 and the vehicle can be suppressed more reliably when the battery pack 1 is transported to the bottom 4 of the vehicle.

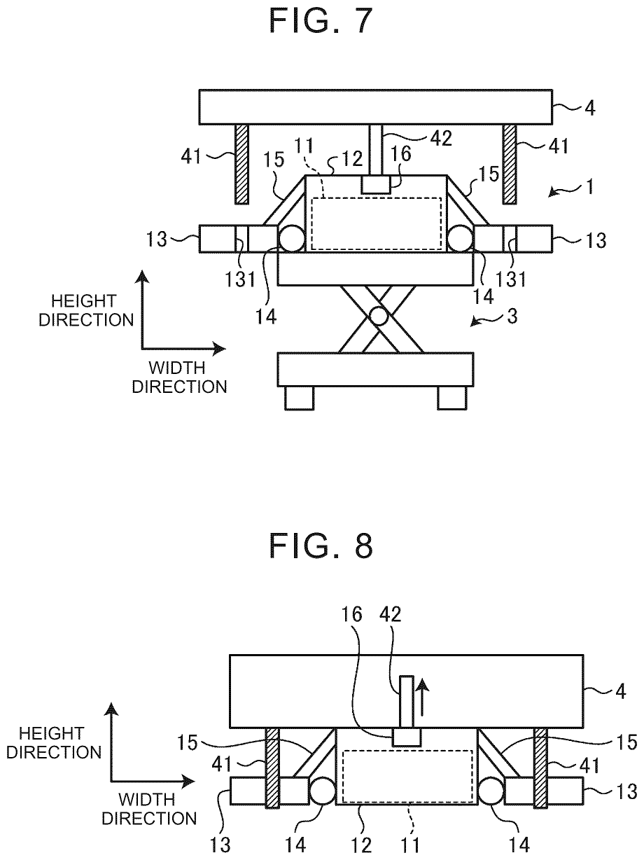

The specific method for operating the folding mechanism 14 to open and close the connection portion 13 is not particularly limited. For example, as shown in FIG. 7, a switch 16 for operating the folding mechanism 14 may be provided at the top of the battery pack 1. For example, the switch 16 operates in conjunction with the operation of the folding mechanism 14. A protrusion 42 for pressing the switch 16 is provided on the bottom 4 of the vehicle to mate with the switch 16.

When the battery pack 1 is lifted by the lift 3 as shown in FIG. 8 after the battery pack 1 is transported to the bottom 4 of the vehicle, the switch 16 is pressed by the protrusion 42 and the folding mechanism 14 operates to unfold the connection portion 13. To suppress interference between the switch 16 and the battery pack 1, it is preferable that the protrusion 42 be retractable into the bottom 4 of the vehicle after the switch 16 is pressed as shown in FIG. 8. With the switch 16 and the protrusion 42, the battery pack 1 can be attached to the bottom 4 of the vehicle by unfolding the connection portion 13 by the simple operation of lifting the battery pack 1 using the lift 3.

In the case where the switch 16 and the protrusion 42 are used, the press of the protrusion 42 by the switch 16 is terminated, for example, when the battery pack 1 attached to the bottom 4 of the vehicle is lowered to detach the battery pack 1. Along with this, the connection portion 13 is folded.

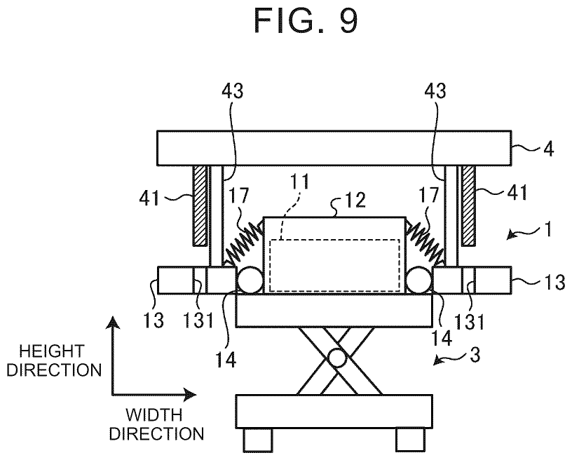

The method for operating the folding mechanism 14 to open and close the connection portion 13 is not limited to the method shown in FIGS. 7 and 8. For example, as shown in FIG. 9, a pair of elastic members 17 and a pair of protrusions 43 may be used.

The elastic member 17 is used in place of the locking mechanism 15. The elastic member 17 connects the side of the housing portion 12 and the top of the connection portion 13. The protrusion 43 is provided on the bottom 4 of the vehicle, and its tip abuts against the top of the connection portion 13.

Until the battery pack 1 is transported to the bottom 4 of the vehicle, the connection portion 13 is folded by being pulled by the elastic force of the elastic member 17. When the battery pack 1 is lifted by the lift 3 after the battery pack 1 is transported to the bottom 4 of the vehicle, the connection portion 13 is pressed by the protrusion 43 and the folding mechanism 14 operates to unfold the connection portion 13 as shown in FIG. 9. To suppress interference between the protrusion 43 and the battery pack 1, it is preferable that the protrusion 43 be retractable into the bottom 4 of the vehicle after the connection portion 13 is pressed. With the elastic member 17 and the protrusion 43, the battery pack 1 can be attached to the bottom 4 of the vehicle by unfolding the connection portion 13 by the simple operation of lifting the battery pack 1 using the lift 3.

In the case where the elastic member 17 and the protrusion 43 are used, the press of the connection portion 13 by the protrusion 43 is terminated, for example, when the battery pack 1 attached to the bottom 4 of the vehicle is lowered to detach the battery pack 1. Along with this, the connection portion 13 is folded.

### Battery Pack Attaching Method

The battery pack attaching method according to the embodiment will be described with reference to FIGS. 1 to 6. In the battery pack attaching method according to the embodiment, the battery pack 1 is transported to the bottom 4 of the vehicle and attached to the bottom 4 of the vehicle without lifting the vehicle. In the battery pack attaching method according to the embodiment, a transport step and an attaching step are performed in this order.

In the transport step, the battery pack 1 is transported to the bottom 4 of the vehicle through the space between the tires 2 of the vehicle. In the transport step, as shown in FIGS. 1 and 2, the battery pack 1 together with the lift 3 is transported to the bottom 4 of the vehicle without operating the lift 3 on which the battery pack 1 is placed. The method for transporting the lift 3 to the bottom 4 of the vehicle is not particularly limited. The lift 3 may be towed to the bottom 4 of the vehicle using any appropriate device, or the lift 3 may move to the bottom 4 of the vehicle autonomously or non-autonomously.

In the transport step, as specifically shown in FIGS. 1 and 2, the battery pack 1 is transported to the bottom 4 of the vehicle in a state in which the connection portions 13 for connecting the battery pack 1 to the bottom 4 of the vehicle are folded in the vehicle height direction by the folding mechanisms 14.

In the attaching step, the battery pack 1 is lifted toward the bottom 4 of the vehicle and attached to the bottom 4 of the vehicle. In the attaching step, as shown in FIGS. 3 and 4, the connection portions 13 are first unfolded in the vehicle width direction by the folding mechanisms 14 at the position of the bottom 4 of the vehicle. With the connection portions 13 unfolded in the vehicle width direction, the lift 3 on which the battery pack 1 is placed is then operated to lift the battery pack 1 as shown in FIG. 5 to attach the battery pack 1 to the bottom 4 of the vehicle. In the attaching step, the fastening members 41 provided on the bottom 4 of the vehicle are fastened to the screw holes 131 of the connection portions 13 to fix the battery pack 1 to the bottom 4 of the vehicle.

With the vehicle and the battery pack attaching method according to the embodiment described above, interference between the battery pack 1 and the vehicle can be suppressed when the battery pack 1 is replaced at the bottom 4 of the vehicle. Since the connection portions 13 of the battery pack 1 are foldable, the width of the power storage device 11 can be increased, and the battery capacity can be increased.

In the vehicle and the battery pack attaching method according to the embodiment, the battery pack 1 is moved under the bottom 4 of the vehicle for replacement without lifting the vehicle. Therefore, the battery pack 1 can easily be replaced at low cost. In the vehicle and the battery pack attaching method according to the embodiment, the battery pack 1 can be replaced quickly. Therefore, the charging time (downtime) of the vehicle can be shortened.

Further effects and modifications can easily be derived by persons skilled in the art. Therefore, broader aspects of the present disclosure are not limited to the specific details and the representative embodiment shown and described above. Accordingly, various modifications may be made without departing from the spirit or scope of the general concept of the disclosure as defined by the appended claims and their equivalents.

What is claimed is:

1. A vehicle comprising a replaceable battery pack mounted on a bottom of the vehicle, wherein
the battery pack includes:
a power storage device;
a housing portion that houses the power storage device;
a pair of connection portions disposed on both sides of the housing portion and connected to the bottom of the vehicle; and
folding mechanisms for the connection portions, and
the folding mechanisms are configured to, when replacing the battery pack:
keep the connection portions folded in a vehicle height direction until the battery pack is transported to the bottom of the vehicle; and
keep the connection portions unfolded in a vehicle width direction after the battery pack is transported to the bottom of the vehicle.

2. The vehicle according to claim 1, further comprising a pair of tires in the vehicle width direction, wherein
when the connection portions are folded by the folding mechanisms, a width of the battery pack is smaller than a distance between the tires, and
when the connection portions are unfolded by the folding mechanisms, the width of the battery pack is larger than the distance between the tires.

3. The vehicle according to claim 1, wherein, when the connection portions are folded by the folding mechanisms, a height of a position of a tip of the connection portion is smaller than a height of the housing portion.

4. The vehicle according to claim 1, wherein:
a switch configured to operate the folding mechanisms is provided at a top of the battery pack; and
a protrusion configured to press the switch is provided at the bottom of the vehicle.

5. A battery pack attaching method comprising:
a transport step of transporting a battery pack to a bottom of a vehicle through a space between a pair of tires of the vehicle; and
an attaching step of attaching the battery pack to the bottom of the vehicle by lifting the battery pack toward the bottom of the vehicle, wherein
in the transport step, the battery pack is transported to the bottom of the vehicle in a state in which connection portions configured to connect the battery pack to the bottom of the vehicle are folded in a vehicle height direction by folding mechanisms, and
in the attaching step, the battery pack is attached to the bottom of the vehicle in a state in which the connection portions are unfolded in a vehicle width direction by the folding mechanisms.
